(19) United States
(12) Patent Application Publication
(10) Pub. No.: US 2014/0162041 A1
(43) Pub. Date: Jun. 12, 2014

(54) Touch Screen Film With Improved Optics and Processability

(71) Applicants: Randy D. Jester, Greer, SC (US); Paul D. Tatarka, Union, KY (US)

(72) Inventors: Randy D. Jester, Greer, SC (US); Paul D. Tatarka, Union, KY (US)

(73) Assignee: TOPAS ADVANCED POLYMERS, INC., Florence, KY (US)

(21) Appl. No.: 13/709,834

(22) Filed: Dec. 10, 2012

(51) Int. Cl. B32B 27/30; B32B 7/06

(52) U.S. Cl. CPC B32B 27/302; B32B 7/06
USPC 428/220; 428/339; 428/334

(57) ABSTRACT

A coextruded film comprising a transparent polymeric inner core layer of thickness less than 250 micron and two peelable outer polymeric layers. In a preferred embodiment, a 50 micron COC core film produced by this technique has a haze of ≦0.5%.

### FIELD OF THE INVENTION

This invention relates to a film having improved optical properties for the inner core after the peelable outer layers are removed including low haze and a smooth, glossy surface. The peelable outer layers before removal provide protection against marring or scratching of the core film during processing and transport and provide mechanical strength for thin core films with insufficient mechanical properties for roll transport, slitting and related processes. Thin, very low haze, low color films are in high demand for display touch screen applications and related fields.

### BACKGROUND OF THE INVENTION

The use of touch screens in mobile devices has become very common and is often an enabling technology in the field of cellular phones, personal computers and readers, and various people to computer/electronics interfaces. Displays for devices of this type require transparent substrates with excellent optical properties and elevated temperature resistance for post processing such as sputtering and annealing. A substrate is typically coated with a conductive coating either by an ITO sputtering process or conventional coating or printing of conductive coatings.

Thermoplastic polymers such as PET that have been extruded, cast into film and then biaxially oriented are commonly utilized as substrate films. Although they are of good optical quality there is a need for films having lower haze and less color. Cyclic olefin copolymer (COC) has inherent low haze and color with grades that provide sufficient high temperature performance but it can difficult to process in a thin film extrusion film process and meet the optical requirements for display film. Flow lines coming from the extrusion die can produce a rough surface on the film that produces an unacceptable level of surface haze. In many applications, total haze on a 50 micron film should be ≦0.5% based on commonly accepted industry standards. Additionally, the mechanical properties of the film can produce problems with roll transport and slitting with film thickness in the high interest area of <50 micron.

It has been disclosed in U.S. Pat. No. 4,617,207 that by co-extruding a thermoplastic resin sheet in the core of two non-adhesive peelable resins that the shear stress introduced at the wall of extrusion dies used to form the thermoplastic film is reduced resulting in films with low double refractive index or birefringence. However, thermoplastic films of desirable materials such as COC were not demonstrated. U.S. Pat. No. 6,808,780 describes co-extruding a thermoplastic resin sheet in the core of two non-adhesive peelable resins but does not describe the use of COC as a core resin and claims a core comprising less than 40% of the extruded film which is an inefficient use of material and equipment.

### SUMMARY OF THE INVENTION

The invention provides a coextruded film comprising a transparent polymeric inner core layer of thickness less than 250 microns and two peelable outer polymeric layers. Materials and processing conditions are selected such that the core film exhibits haze of ≦5% when measured on a 50 micron core layer thickness. In a preferred embodiment, the inner or core layer constitutes the majority of the extruded film, that is, at least and preferably more than 50% of the thickness of the multilayer extruded structure. A 50 micron core COC film produced by this technique has a haze of ≦0.5%.

Other aspects and advantages of the invention will become apparent from the discussion which follows.

### BRIEF DESCRIPTION OF DRAWINGS

The invention is described in detail below with reference to the drawings wherein:

FIG. 1 is a plot of light transmittance versus wavelength for a TOPAS® COC material; and

FIG. 2 is a plot of glass transition temperature (Tg) vs. norbornene content for amorphous COC resins.

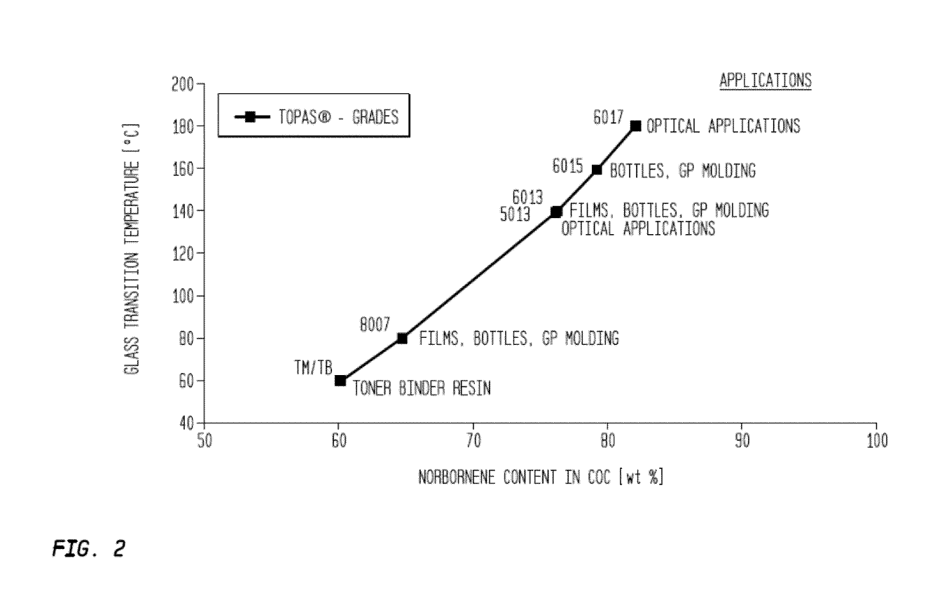

### DETAILED DESCRIPTION OF THE INVENTION

The invention is described below with reference to numerous embodiments. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below; % means weight percent or mol % as indicated, or in the absence of an indication, refers to weight percent. mils refers to thousandths of an inch and so forth.

“Consisting essentially of” and like terminology refers to the recited components and excludes other ingredients which would substantially change the basic and novel characteristics of the composition or article. Unless otherwise indicated or readily apparent, a composition or article consists essentially of the recited components when the composition or article includes 90% or more by weight of the recited components. That is, the terminology excludes more than 10% unrecited components.

A “film” refers to a planar structure of generally uniform thickness usually having a thickness (gauge) of 15 mils or less. Typical film structures have thicknesses of from 2 to 8 mils, in many cases 4-6 mils.

“Amorphous cycloolefin polymer” and like terminology refers to a COP or COC polymer which exhibits a glass transition temperature, but does not exhibit a crystalline melting temperature nor does it exhibit a clear x-ray diffraction pattern.

“COC” polymer and like terminology refers to a cyclolefin copolymer prepared with acyclic olefin monomer and cyclolefin monomer by way of addition copolymerization.

“COP polymer” and like terminology refers to a cycloolefin containing polymer prepared exclusively from cycloolefin monomer, typically by ring opening polymerization.

“Partially crystalline cycloolefin elastomer of norborene and ethylene”, and like terminology refers to a partially crystalline elastomer which contains cyclolefin repeat units, exhibits both a glass transition temperature and a melting point and rubbery modulus at room temperature and below. A typical elastomer, for example, is an ethylene/norbornene copolymer elastomer having a norbornene content of about 8-9 mol %, with a target of 8.5 mol %. It is seen hereinafter that partially crystalline COC elastomers may exhibit a rubbery modulus plateau between about 10° C. and 20° C. and 80° C. and 90° C. As to thermal properties and crystallinity, these polymers optionally feature two glass transition temperatures of about 6° C. and below about −90° C. as well as an exemplary crystalline melting point of about 84° C. These polymers exhibit flexibility and elastic behavior, that is, elongation before breaking of up to 200% and more at temperatures as low as −50° C. and below as is discussed herein. Unlike amorphous COP and COC polymers, these COC elastomers typically contain between 10 and 30 percent crystallinity. While these materials are typically prepared by the catalytic reaction of norbornene and ethylene as hereafter described, additional monomers may be included if so desired. Likewise, the materials may include grafted on units and crosslinkers if so desired and polymerization techniques such as ring opening metathesis may be employed. Preferably, the partially crystalline, cycloolefin elastomer of norbornene and ethylene is predominantly, more than 50% by weight, norbornene and ethylene repeat units, more preferably more than 80% by weight norbornene and ethylene repeat units and still more preferably, more than 90% by weight norbornene and ethylene repeat units.

Unless otherwise indicated, the Tg of the polymers was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis” (American Society for Testing of Materials, Philadelphia, Pa.).

Storage Modulus, E′ and Loss Modulus, E″, are measured by dynamic mechanical analysis (DMA), following ASTM D5026-06 and ASTM D4065-06 Test Methods, employing frequency of 1.0 Hz and a heating rate of 2° C. per minute over a temperature range of from −120° C. to 150° C. Storage or loss modulus may alternatively be measured in accordance with test methods ASTM D5279-08 (torsion) or ASTM D5023-07 (flexure).

Haze is determined in accordance with ASTM Test Method D 1003-00B. Haze values for nominal thicknesses are used to normalize haze to a particular thickness. A nominal thickness haze value may be calculated for a film by multiplying the measured haze of a specimen by the nominal thickness and dividing by the actual thickness of the specimen upon which haze was measured. For example, the 6 mil haze value is calculated from haze measured on a 5 mil sample by multiplying by 6/5 or 1.2.

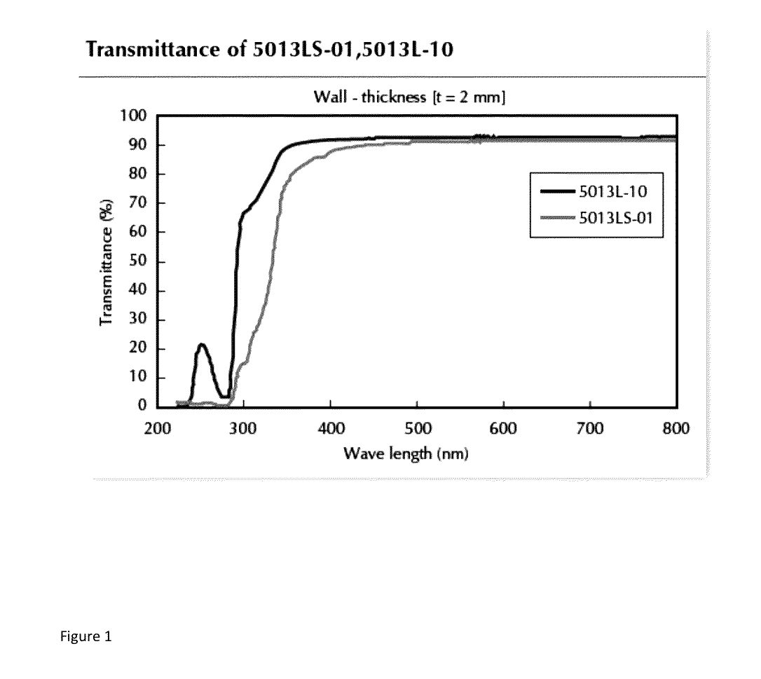

A transparent material or film is one which allows light in the visible spectrum to pass through a film without substantial absorbence. Preferably, a transparent material is one which exhibits a transmittance of more than 50% through a thickness of 2 mm at wavelengths of from 450-700 nm. In FIG. 1, a characteristic light transmittance curve is shown for TOPAS® COC material.

Unless otherwise indicated, a Test Method in effect as of Dec. 1, 2012 is utilized.

### Amorphous Cyclolefin Containing Polymers

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Preference is given to cycloolefins of the formulae I, II, III, IV, V or VI, or a monocyclic olefin of the formula VII:

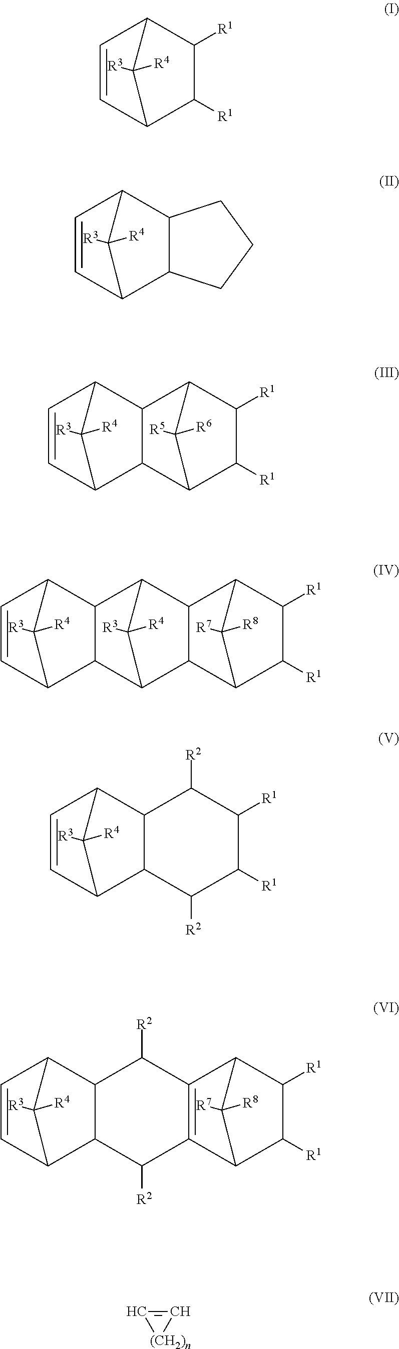

wherein R¹, R², R³, R⁴, R⁵, R⁶, R⁷ and R⁸ are the same or different and are H, a C₆-C₂₀-aryl or C₁-C₂₀-alkyl radical or a halogen atom, and n is a number from 2 to 10.

Specific cycloolefin monomers are disclosed in U.S. Pat. No. 5,494,969 to Abe et al. Cols. 9-27, for example the following monomers:

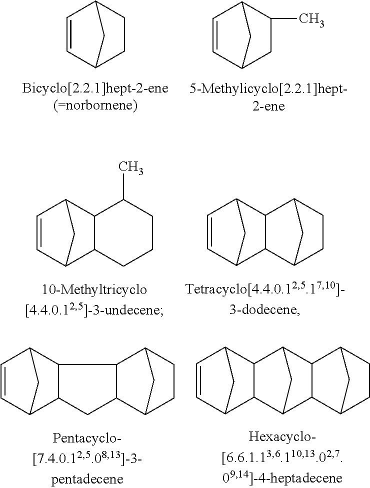

and so forth. The disclosure of U.S. Pat. No. 5,494,969 to Abe et al. Cols. 9-27 is incorporated herein by reference.

U.S. Pat. No. 6,068,936 and U.S. Pat. No. 5,912,070 disclose several cycloolefin polymers and copolymers, the disclosures of which are incorporated herein in their entirety by reference. Cycloolefin polymers useful in connection with the present invention can be prepared with the aid of transition-metal catalysts, e.g. metallocenes. Suitable preparation processes are known and described, for example, in DD-A-109 225, EP-A-0 407 870, EP-A-0 485 893, U.S. Pat. Nos. 6,489,016, 6,008,298, as well as the aforementioned U.S. Pat. Nos. 6,608,936, and 5,912,070, the disclosures of which are all incorporated herein in their entirety by reference. Molecular weight regulation during the preparation can advantageously be effected using hydrogen. Suitable molecular weights can also be established through targeted selection of the catalyst and reaction conditions. Details in this respect are given in the abovementioned specifications.

Particularly preferred cycloolefin copolymers include cycloolefin monomers and acyclic olefin monomers, i.e. the above-described cycloolefin monomers can be copolymerized with suitable acyclic olefin comonomers. A preferred comonomer is selected from the group consisting of ethylene, propylene, butylene and combinations thereof. A particularly preferred comonomer is ethylene. Preferred COCs contain about 10-80 mole percent of the cycloolefin monomer moiety and about 90-20 weight percent of the olefin moiety (such as ethylene). Cycloolefin copolymers which are suitable for the purposes of the present invention typically have a mean molecular weight M_{W} in the range from more than 200 g/mol to 400,000 g/mol. COCs can be characterized by their glass transition temperature, Tg, which is generally in the range from 20° C. to 200° C., preferably in the range from 30° C. to 130° C. In one preferred embodiment the cyclic olefin polymer is a copolymer such as TOPAS® 8007F-04 which includes approximately 36 mole percent norbornene and the balance ethylene. TOPAS® 8007F-004 has a glass transition temperature of about 78° C. Other preferred embodiments include melt blends of partially crystalline cycloolefin elastomer and amorphous COC materials with low glass transition temperatures. One preferred material for blending with partially crystalline cycloolefin elastomer is TOPAS® 9506-04 which has a Tg of about 68° C. Still another preferred amorphous COC for blending with partially crystalline cycloolefin elastomer is TOPAS® 9903D-10 which has a glass transition temperature of about 33° C.

COCs are particularly preferred because their temperature performance can be tailored by changing the cycloolefin content of the polymer. Table 1 lists molecular weights of specific COC material and COC elastomer, specifically TOPAS® Elastomer E-140 (“E-140”) material discussed hereinafter.

TABLE 1
Melt Volume Flow Rate and Molecular Weight for TOPAS ® Materials

| | | | 9903- | 9506F- | | 8007F- | |
|---|---|---|---|---|---|---|---|
| | Units | E-140 | D10 | 04 | 8007F-04 | 400 | 6013F-04 |
| Melt Volume Rate | | | | | | | |
| at 260° C.; 2.16 kg load | ml/10 min | 12 | 8 | — | 32 | — | 14 |
| Method: ISO 1133 | | | | | | | |
| at 230° C.; 2.16 kg load | ml/10 min | — | 3.3 | 6 | 12 | 11 | 1 |
| Method: ISO 1133 | | | | | | | |
| WeightAverage | | | | | | | |
| Molecular Weight (M_{w}) | | | | | | | |
| Chloroform at 35° C. | kg/mol | — | 138 | 114 | 98 | — | 87 |
| 1,2,4 Trichlorobenzol at | kg/mol | 154 | — | — | — | — | — |
| 140° C. | | | | | | | |
| Method GPC | | | | | | | |
| Number Average | | | | | | | |
| Molecular Weight (Mₙ) | | | | | | | |
| Chloroform at 35° C. | kg/mol | — | 42 | 55 | 40 | — | 40 |
| 1,2,4 Trichlorobenzol at | kg/mol | 68 | — | — | — | — | |
| 140° C. | | | | | | | |
| Method GPC | | | | | | | |
| Polydispersity | | 2.26 | 3.29 | 2.07 | 2.45 | — | 2.18 |

Suitable COC material is also available from Mitsui Petrochemical Industries of Tokyo, Japan. Suitable COP materials are available from Zeon Chemicals of Louisville K.Y., under the trade name of Zeonex®, or from JSR Corporation of Tokyo, Japan, under the trade name of Arton®.

### Cycloolefin Copolymer Elastomers

COC elastomers are elastomeric cyclic olefin copolymers also available from TOPAS Advanced Polymers. E-140 polymer features two glass transition temperatures, one of about 6° C. and another glass transition below −90° C. as well as a crystalline melting point of about 84° C. Unlike completely amorphous TOPAS COC grades, COC elastomers typically contain between 10 and 30 percent crystallinity by weight. Typical properties of E-140 grade appears in Table 2:

TABLE 2
E-140 Elastomer Properties

| Property | Value | Unit | Test Standard |
|---|---|---|---|
| Physical Properties | | | |
| Density | 940 | kg/m³ | ISO 1183 |
| Melt volume rate (MVR) - @ | 3 | cm³/10 min | ISO 1133 |
| 2.16 kg/190° C. | | | |
| Melt volume rate (MVR) - @ | 12 | cm³/10 min | ISO 1133 |
| 2.16 kg/260° C. | | | |
| Hardness, Shore A | 89 | — | ISO 868 |
| WVTR - @ 23° C./85 RH | 1.0 | g*100 μm/m² * | ISO 15106-3 |
| | | day | |
| WVTR - @ 38° C./90 RH | 4.6 | g*100 μm/m² * | ISO 15106-3 |
| | | day | |
| Mechanical Properties | | | |
| Tensile stress at break (50 | >19 | MPa | ISO 527-T2/1A |
| mm/min) | | | |
| Tensile modulus (1 mm/min) | 44 | MPa | ISO 527-T2/1A |
| Tensile strain at break | >450 | % | ISO 527-T2/1A |
| (50 mm/min) | | | |
| Tear Strength | 47 | kN/m | ISO 34-1 |
| Compression set - @ | 35 | % | ISO 815 |
| 24 h/23° C. | | | |
| Compression set - @ | 32 | % | ISO 815 |
| 72 h/23° C. | | | |
| Compression set - @ | 90 | % | ISO 815 |
| 24 h/60° C. | | | |
| Thermal Properties | | | |
| Tg - Glass transition | 6 | ° C. | DSC |
| temperature (10° C./min) | <−90 | | |
| Tₘ - Melt temperature | 84 | ° C. | DSC |
| Vicat softening temperature, | 64 | ° C. | ISO 306 |
| VST/A50 | | | |

As seen above, E-140 has multiple glass transitions (Tg); one occurs at less than −90° C. and the other occurs in the range from −10° C. to 15° C.

Further details as to Topas® materials are found in United States Patent Application Publication no. 20110256373 of Tatarka et al. Oct. 20, 2011, the disclosure of which is incorporated herein by reference.

### Styrene Block Copolymer Elastomers

The following references disclose Kraton® styrene block copolymer elastomers and are also incorporated herein by reference:
U.S. Pat. No. 7,365,130, issued Apr. 29, 2008, entitled “Cycloolefinic Copolymer for High Modulus Film”, to Rivett et al.;
U.S. Pat. No. 7,267,855, issued Sep. 11, 2007, entitled “Articles Prepared From Hydrogenated Controlled Distribution Block Copolymers”, to Handlin, Jr. et al.;
U.S. Pat. No. 6,544,610, issued Apr. 8, 2003, entitled “Container and Blow-Molded Product”, to Minami et al.;
U.S. Pat. No. 6,090,888, issued Jul. 18, 2000, entitled “Cyclic Olefin Polymer Blends Exhibiting Improved Impact Resistance and Good Transparency”, to Khanarian et al.; U.S. Pat. No. 4,918,133, issued Apr. 17, 1990, entitled “Cycloolefin Type Random Copolymer Compositions”, to Moriya et al.;
U.S. Pat. No. 4,418,178, issued Nov. 29, 1983, entitled “Impact Modified Polymers of Cycloolefins”, to DeWitt;
U.S. Pat. No. 4,166,083, issued Aug. 28, 1979, entitled “Rubber Composition and Process for Preparation Thereof”, to Ueda et al.;
United States Patent Application Publication No. US 2008/0300363, published Dec. 4, 2008, entitled “Blends of Co-Precipitated Hydrogenated Ethylene-Dicyclpentadiene and Elastomeric Polymers to Provide Impact Modified Structural Polyolefins”, of Baugh et al.;
United States Patent Application Publication No. US 2008/0033112, published Feb. 7, 2008, entitled “Polymer Compositions Comprising Cyclic Olefin Copolymers and Polyolefin Modifiers”, of Squire et al.; and
United States Patent Application Publication No. US 2007/0037927, published Feb. 15, 2007, entitled “Compatibilized Blends of ABS Copolymer and Polyolefin”, of Yang.

The thermoplastic resin sheet according to this invention is required to be transparent, have a low inherent haze of <0.5% at 50 micron thickness and low inherent color and have a thickness of less than 250 micron. Thermoplastic resins usable as the transparent core layer in the above-described sheet include cyclic olefin copolymers (COC). Although the thermoplastic resins listed above by way of example may be shaped into film structures by the extrusion technique, calendering technique or solution casting technique, it is preferable to extrude a first thermoplastic resin and a second thermoplastic resin with relatively low or no adhesion to the first thermoplastic resin into at least three layers so that the first thermoplastic resin forms a core layer and the second thermoplastic resin forms outer layers laminated on both surfaces of the core layer, and then to peel off the outer layers to expose the product core layer. Another embodiment is to extrude three resins, a core and two different skin resins. The sheets according to this invention can advantageously be used, owing to their characteristic feature of low haze and color, as substrates for touch screen film, and in other fields requiring film with good optical properties.

According to the present invention, a thermoplastic film is produced by co-extruding a first thermoplastic resin and a second thermoplastic resin into a sheet-like structure so that the resulting layer of the first thermoplastic resin is covered on both surfaces thereof with outer layers of the second thermoplastic resin, and then by peeling off the outer layers of the second thermoplastic resin to obtain a sheet of the first thermoplastic resin. The peeling off of the protective outer layers can be done at any part of the production process or in any subsequent process where it is advantageous to expose the surface of the core film product. Suitable techniques and equipment are disclosed in U.S. Pat. No. 6,808,780 to Laney et al., the disclosure of which is incorporated herein by reference.

The first thermoplastic transparent core resin can comprise a COC, COP, polycarbonate, polyester, polystyrene, or polyacrylate. Among these exemplary resins, COC and COP resins are preferred. The second thermoplastic outer layer resin useful in the practice of this invention is preferably immiscible or poorly miscible with (does not mix or blend with) the first thermoplastic resin. This results in the second thermoplastic resin having low adhesion to the first thermoplastic resin, and its type can be chosen in view of the type of its matching first thermoplastic resin. A slight interlayer adhesion is preferred so that the layers do not immediately separate as the film is extruded and quenched. To this effect the second peelable polymer layer resin can be modified with additives such as slip or cling agents to fine tune release characteristics. The objective is for the first and second resins to have a clean, peelable interface so that the second and/or third resin can be readily removed from the core at the time desired.

The first thermoplastic resin and the second thermoplastic resin, which can be used in the present invention, may be of any combination so long as layers of the second thermoplastic resin can be readily peelable from a layer of the first thermoplastic resin after their co-extrusion into multiple adjacent layers. When a COC resin is chosen by way of example as the first thermoplastic resin, it is possible to choose as the matching second thermoplastic resin polyesters such as PET, PETG, PC, nylons, or other non-olefinic thermoplastic resins. The combination of a COC with PET is especially advantageous because it results in good release characteristics and a substantially defect free surface of the core COC layer after being peeled apart.

The term “immiscible” or “non-adhesive” as used herein defines not only combinations in which neither resin layer adheres to the other but also combinations in which both resin layers are readily peelable. In the present invention, the first thermoplastic resin and the second thermoplastic resin are co-extruded in such a way that the second thermoplastic resin covers both surfaces of the resulting layer of the first thermoplastic resin. The co-extrusion may be carried out by using the feed block method in which both resins are laminated by a feed block immediately before their entry to a T die and then fed to the T die (see, for example, U.S. Pat. Nos. 3,557,265, 3,476,627 and 4,336,012) or the multi-manifold method in which both resins are laminated in a T die; see, for example, Kenkichi Murakami, “Plastics Age” 21(9), 74 (1975)!.

Pertaining to the laminated layer structure of the first and second thermoplastic resins to be obtained upon co-extrusion, it is generally advantageous to use the same resin as the second thermoplastic resin which makes up both outer layers, in other words, to take a structure of three layers made up of two types of resins, i.e., a 2/1/2-type structure because the above structure does not require handling a variety of resins. It is of course possible to use different of resins as the second thermoplastic resin making up both outer layers so that the resulting laminate takes a structure of three layers made up of three different resins. It may also be feasible to laminate additional layers made of another resin over the outer layers made of the second thermoplastic resin, for example, into a structure such as 3/2/1/2/3. Alternatively, the co-extruded laminate may take another structure such as 2/1/2/1/2. Further, it may also take a further structure of 2/1/3/1/2 so as to obtain a final sheet having the 1/3/1 structure. In addition it may also take a further structure 2/1/1′/2′ wherein the resin 2′ is nonadhesive to the resin I′ so as to take a final sheet having 1/1′ structure. The proportion of the thickness of the first thermoplastic resin in the total thickness of each co-extruded sheet-like laminate is preferably 50% or greater. If the proportion is less than 50%, the resulting sheet of the first thermoplastic resin, the product core sheet is produced at low efficiency and the outer peelable sheet is wasted at a high level.

The peeling-off of the outer sheets made of the second thermoplastic resin from the sheet-like laminate can be effected with ease because the first and second thermoplastic resins are immiscible and nonadhesive to each other. It is desirable to peel off the outer sheets immediately before winding the core layer into roll form in order to keep the core layer free from deposition of dust or scratches. However, the outer peelable layers can be left on for further subsequent processing as desired. This subsequent processing can include laser cutting, die cutting, or additional slitting. Additionally, only one side of the non-adherent film may be removed, thereby exposing one side of the transparent core film for coating or treatment while maintaining the protection and mechanical strength of the other sides peelable layer. As previously mentioned desirable thicknesses of the core layer or layers is less than 250 micron and generally should be no less than 10 micron. In a preferred embodiment the thickness would be a range between 25 and 50 micron. The thickness of each of the outer peelable layers in this preferred embodiment is desirably at least 50% thinner than the core layer to help minimize waste of outer layer material.

The thermoplastic resin useful in the practice of the process of this invention in the outer peelable layers may also contain a variety of addenda such as processing aids, release agents, lubricants, slip agents, antilock, and plasticizers without causing problems. Such addenda are well known in the art as is referenced in “Plastics Additives Handbook”, 4^{th} Edition edited by R. Gachter and H. Muller.

It is desirable to wind the first thermoplastic resin of the core layer into a wound roll form after peeling the outer layers away. It is sometimes desirable to interleave a masking film into the roll to protect the core layer and to prevent it from sticking to itself. As a means to reduce processing steps and the cost of the rolled film one of the two outer layers could be kept adjacent to the core layer and wound into the roll along with the core layer serving as a masking film.

The core layer films of this invention can be used as a component of an touch screen due to the low haze, low color and smooth surface of the film. Typical devices that such touch screens are utilized in are cellular phones, laptop computers and tablets, human to control system interface screens, game system screens, LCD, LED and OLED displays and any flat screen entertainment device. Suitably, core layer films of the of the invention are incorporated into multilayer touch screen panels having the features described in U.S. Pat. No. 8,223,278 to Kim et al., the disclosure of which is incorporated herein by reference.

### Example 1

### Comparative

TOPAS 6015 from TOPAS Advanced Polymers was dried in a desiccant dryer at 110° C. for 8 hours. A 35.5 cm. (14″) wide Cloeren single manifold “T” type die was fed by a 3.2 cm (1.25″) extruder with TOPAS 6015. The die was maintained at 260 C and the COC melt temperature was 268 C. As the extruded sheet emerged from the die, a 50 micron film was cast onto a quenching three roll set with roll temperatures of 112 C, 93 C, and 82 C respectively from the beginning to the exit end of the film line.

Haze was measured with a BYK-GardnerHaze-gard Plus4725 and found to be at an unacceptable 0.9% for the 50 micron (2-mil) film.

### Example 2

TOPAS 6015 from TOPAS Advanced Polymers was dried in a desiccant dryer at 110° C. for 8 hours. A 3-layer ABA Cloeren feedblock fed a 35.5 cm. (14″) wide Cloeren single manifold “T” type die to produce a three layer ABA polymer film layer structure. The feedblock was fed by two extruders. One 2.54 cm (1″) extruder fed the two equal “A” layers of the feedblock with DAK Americas Laser+C9921 PET. One 3.2 cm (1.25″) extruder fed the core feedblock layer with TOPAS 6015. The die was maintained at 260 C and the COC melt temperature was 265 C. As the extruded sheet emerged from the die, it was cast onto a quenching three roll set with roll temperatures of 74 C, 71 C, and 65 C respectively from the beginning to the end of the film line

The two 25 micron non-adhering layers were removed and haze was measured with a BYK-GardnerHaze-gard Plus4725 and found to be at an acceptable 0.3% for the 50 micron (2-mil) core film.

### Example 3

TOPAS 6015 containing 2.5% of a Kraton SBC blend (72% Kraton MD1537+28% Kraton A1536 as a refractive index matched impact modifier) was dried in a desiccant dryer at 110° C. for 8 hours. A 3-layer ABA Cloeren feedblock fed a 35.5 cm. (14″) wide Cloeren single manifold “T” type die to produce a three layer ABA polymer film layer structure. The feedblock was fed by two extruders. One 2.54 cm (1″) extruder fed the two equal “A” layers of the feedblock with DAK Americas Laser+C9921 PET. One 3.2 cm (1.25″) extruder fed the core feedblock layer with impact modified TOPAS 6015. The die was maintained at 260 C and the COC melt temperature was 268 C. As the extruded sheet emerged from the die, it was cast onto a quenching three roll set with roll temperatures of 74 C, 71 C, and 65 C respectively from the beginning to the end of the film line

The two 25 micron non-adhering layers were removed and haze was measured with a BYK-GardnerHaze-gard Plus4725 and found to be at an acceptable 0.5% for the 50 micron (2-mil) film.

While the invention has been described in detail, modifications within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A coextruded film comprising a transparent polymeric inner core layer of thickness less than 250 micron and two peelable outer polymeric layers wherein the inner layer constitutes at least 25% of the total film thickness and materials and processing conditions are selected such that the core film exhibits haze of ≦5% when measured on a 50 micron core layer thickness.

2. The co-extruded film of claim 1 wherein the two peelable outer polymeric layers comprise a polyester derivative repeating unit.

3. The co-extruded film of claim 1 wherein the transparent polymeric inner layer is between 10 and 125 micron in thickness.

4. The co-extruded film of claim 1 wherein the two peelable outer polymeric layers contain an antiblock, slip agent, or cling agent.

5. The co-extruded film of claim 1 wherein the transparent polymeric inner layer contains a release agent, lubricant, slip agent, or antiblock agent

6. The co-extruded film of claim 1 wherein the two peelable outer polymeric layers comprise the same composition.

7. The co-extruded film of claim 1 wherein the two peelable outer polymeric layers comprise different compositions.

8. The co-extruded film of claim 1 in the form of a transparent layer material obtained by the separation of the two peelable outer polymeric layers of claim 1 from the inner layer.

9. The co-extruded film of claim 8 in the form of a transparent layer material as a component of a touch screen display.

10. The co-extruded film of claim 8 in the form of a transparent layer material as a component of a flat screen display.

11. A coextruded film comprising a transparent polymeric inner core layer of thickness less than 125 micron and two peelable outer polymeric layers wherein the inner layer constitutes at least 50% of the total film thickness and exhibits haze of ≦0.5% when measured on a 50 micron core layer thickness.

12. The co-extruded film of claim 11 wherein the inner transparent layer constitutes more than 80% of the total film thickness.

13. The co-extruded film of claim 11 wherein the inner transparent layer is COC at a 50 micron thickness and constitutes more than 50% of the total extruded film thickness and exhibits a haze of ≦0.5%.

14. The co-extruded film of claim 11 wherein the inner layer is COC containing a refractive index matched impact modifier as a <10% component.

15. The co-extruded film of claim 14 wherein the refractive index matched impact modifier is a blend of styrene block copolymer elastomers.

16. The co-extruded film of claim 14 wherein the refractive index matched impact modifier is a partially crystalline elastomer of norbornene and ethylene.

17. A coextruded film comprising a transparent polymeric inner core layer of amorphous cycloolefin polymer having a thickness less than 250 microns and two peelable outer polymeric layers wherein the inner layer constitutes at least 50% of the total film thickness and exhibits haze of ≦0.75% when measured on a 50 micron core layer thickness.

18. The co-extruded film of claim 17 wherein the inner layer comprises a polymer selected from COC polymers and COP polymers.

19. The co-extruded film of claim 18 wherein the inner layer comprises a COC polymer.

20. The co-extruded film of claim 18 wherein the inner layer comprises an impact modifier selected from partially crystalline elastomers of norbornene and ethylene and blends of styrene block copolymer elastomers.
